(19) United States
(12) Patent Application Publication
(10) Pub. No.: US 2024/0345417 A1
(43) Pub. Date: Oct. 17, 2024

(54) Easy Tint Frames

(71) Applicant: Terrell Gilmer, Euless, TX (US)

(72) Inventor: Terrell Gilmer, Euless, TX (US)

(21) Appl. No.: 18/442,899

(22) Filed: Feb. 15, 2024

Related U.S. Application Data
(60) Provisional application No. 63/446,058, filed on Feb. 16, 2023.

(51) Int. Cl. G02C 7/02

(52) U.S. Cl. CPC G02C 7/022

(57) ABSTRACT

A device comprising an improved transition lens for eye glasses that allows the wearer of the eye glasses to control the tint of the lenses.

### CROSS-REFERENCE TO RELATED APPLICATIONS

Applicant claims priority to U.S. Provisional Patent Application 63/446,058, filed Feb. 16, 2023, the disclosure of which is incorporated by reference herein in its entirety.

### DESCRIPTION OF THE DRAWINGS

FIG. 1 is a perspective view of the lenses of eye glasses with a control level attached thereto, comprising an embodiment of the present invention.

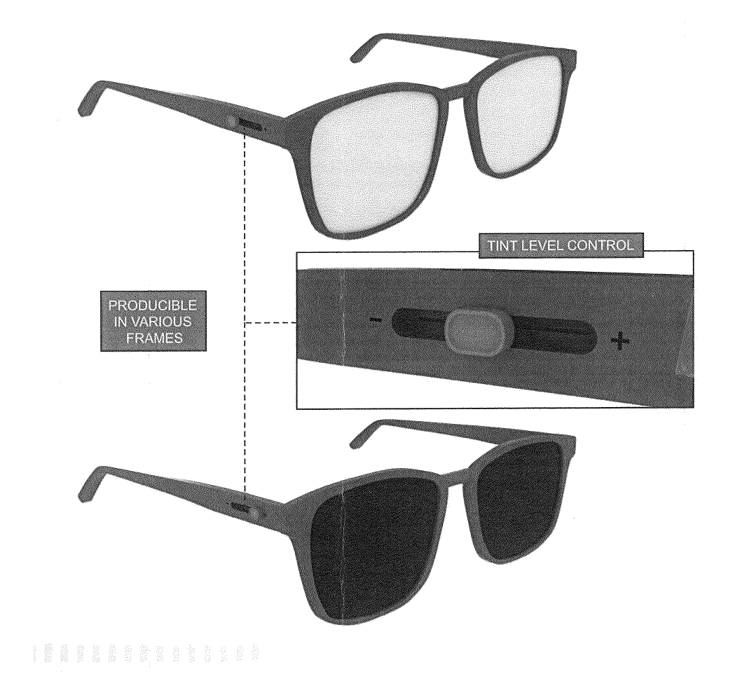

### DETAILED DESCRIPTION

The present invention comprises an improved photochromic or transition lens for eye glasses, such as prescription eye glasses, that would allow the wearer of the eye glasses to control the tint of the lenses. Instead of transitioning eye glasses due to exposure to ultraviolet light, the present invention can comprise a lever that controls the tint.

The invention can comprise lenses for the eye glasses, which would rest within the front of the frame, which could be produced from metal or plastic. Using the present invention, the lenses of the eye glasses can darken or lighten due to a control lever that can rest within one of the arms or temples, near the front of the frame. This would allow the color of the lenses to lighten or darken, even when indoors. Further, the present invention can be used in a plethora of styles and colors for wearing by men, women and children.

The appealing features of the present invention are its effectiveness, ability to protect the wear's eyes, fashionable appearance and reasonable price. The present invention can feature lenses that will lighten or darken according to the wearer's desire instead of based upon exposure to ultraviolet light. This could allow the darkened lenses to be worn indoors for a trendy appearance. The present invention can also provide protection from the harmful rays of the sun for delicate eyes. This may possibly reduce the incidences of various optical diseases including cataracts. The present invention can also ensure the wearer has sunglasses available at all times. Thus, the user would not have to worry about transporting a separate pair that may easily be lost or misplaced.

The lenses of the present invention can be comprised of a plastic such as polycarbonate. Polycarbonates tend to be unbreakable, lightweight, thin and ultraviolet attenuating, which are popular features with consumers. The frames can be comprised of plastic such as nylon or vinyl. Alternatively, the frames can be produced from a metal such as titanium.

In sum, the present invention fulfills the need for an improved pair of photochromatic glasses. Prescription lens wearers can lighten or darken the lens by moving a built in control lever.

The benefits of the present invention are as follows: the present invention a) allows eyeglass wearers to add tint to their lenses for sun protection any time, b) enables lenses to darken and lighten faster than with existing transition lenses, c) eliminates the need to carry and change to a separate pair of sunglasses or wait for the tint to change, d) does not negatively affect the vision enhancement of the lenses, e) saves time and effort, f) is practical, reliable and easy to operate and g) is convenient, effective and affordably priced.

The features of the present invention are as follows: a) the present invention is an improved photochromic or transition lens for eye glasses, such as prescription glasses, that allows the wearer to manually control the tint, b) the tint control or control lever can be built onto the lens itself, on the side of the frame or can rest within one of the arms or templates near the front of the frame, c) the tint control can have three levels: no tint, low tint or high tint, d) the present invention can also comprise Digital Tint, e) the materials for the present invention can be produced from those currently used for eyeglass lenses and frames, f) the present invention can be offered in a variety of styles and colors for men, women and children and g) the user of the present invention can wear the present invention in the normal manner that one would wear eye glasses and can adjust the tint level with a lever or tint control.

An embodiment of the present can be shown in the attached illustration.

It should be understood that the present invention is not limited to the embodiments disclosed, but is capable of numerous rearrangements, modifications, and substitutions of parts and elements without departing from the spirit of the invention.

What is claimed is:

1. An easy tint frame comprising the above elements, systems and methods.
